(19) United States
(12) Patent Application Publication
(10) Pub. No.: US 2013/0068852 A1
(43) Pub. Date: Mar. 21, 2013

(54) SPRAY SYSTEM AND METHOD FOR SPRAYING A SECONDARY FLUID INTO A PRIMARY FLUID

(71) Applicants: Dieter Wurz, Baden-Baden (DE); Stefan Hartig, Achern (DE)

(72) Inventors: Dieter Wurz, Baden-Baden (DE); Stefan Hartig, Achern (DE)

(21) Appl. No.: 13/639,980

(22) PCT Filed: Apr. 8, 2011
(86) PCT No.: PCT/EP11/55521

§ 371 Date: Nov. 15, 2012

(30) Foreign Application Priority Data
Apr. 9, 2010 (DE) 102010014580.7

(51) Int. Cl. B05B 7/00; B05B 15/02

(52) U.S. Cl. CPC B05B 7/00; B05B 15/0208
USPC 239/8; 239/421; 239/403; 239/106; 239/112; 239/10

(57) ABSTRACT

A spray system for spraying a secondary fluid into a primary fluid. The secondary fluid is gaseous, liquid or contains fine particulate solids to be dispersed in the primary fluid. The spray system has a central nozzle for the primary fluid and a nozzle for the secondary fluid. The nozzle housing has a tubular design and the central nozzle is provided with a central passage for the primary fluid. The passage, as seen in the flow direction, has convergent inlet region, a constriction and a divergent outlet part. An outlet opening for the secondary fluid is arranged on the downstream end of the nozzle housing and an outlet opening generates a spray jet of secondary fluid that surrounds the primary fluid exiting the central passage in a substantially ring-shaped manner.

The invention refers to a spray system for spraying a secondary fluid into a primary fluid, wherein the secondary fluid is gaseous or liquid or contains fine particulate solids which are to be dispersed in the primary fluid, having at least one central nozzle for the primary fluid and at least one nozzle for spraying the secondary fluid, wherein a nozzle housing of the nozzle is of tubular construction and the central nozzle has a central passage for the primary fluid.

In a large number of process engineering plants, through which flows a primary fluid, the object is to mix a secondary, liquid or gaseous fluid, or fine particulate solids, as homogeneously as possible into the primary fluid. For this purpose, nozzles are used. Since the mixing in of the secondary fluid—among which should also be counted the fine particulate solids suspended in a carrier fluid—is to be carried out within a very short migration distance, there is a requirement for a large number of nozzles which are distributed over the cross section of the process engineering plant through which flows the primary fluid. This is associated with high costs, especially also for the spray lances—via which the secondary fluid is transported to the spray nozzles—which are required in this case.

In many cases, the secondary fluid is introduced into the primary fluid by means of an auxiliary atomizing medium. This auxiliary atomizing medium can consist of compressed air or steam, for example.

In the case of a so-called evaporative cooler for hot flue gases, water, as the secondary fluid in the form of fine droplets, is usually sprayed into the primary fluid, specifically flue gas. As a rule, there is great interest in the time which is required for the evaporation of the droplets being as short as possible since otherwise the dimensions of the process engineering plant turn out to be very large, which is associated with high plant costs. It is not only a question of the droplet size distribution in the spray jet of the secondary fluid close to the outlet of the spray nozzles, however, but also a question of the intensity of the mixing of the primary gas to be cooled into the spray jet. The more intensive this mixing is, the shorter the evaporation distance is. In conventional nozzles, the mixing of the primary gas into the spray jet is carried out across the cone envelope of the spray jet. The primary gas flows through the peripheral zones of the spray jet towards the axis of the spray jet and in the process also drags droplets towards the jet axis along with it as a result of the flow resistance. Consequently, unfavorable boundary conditions exist on the jet axis for the evaporation of the droplets because the flue gas en route to the axis of the spray jet has been already cooled and enriched with steam. In addition, particularly high droplet flow densities usually occur close to the jet axis, which for obvious reasons is also extremely unfavorable for a fast evaporation.

A similar problem exists for dispersing solids in a primary gas flow. A high particle density exists on the axis of the spray jet of the introduced solid suspension since the primary gas which is mixed in towards the axis of the spray jet entrains fine solid particles from the jet periphery towards the jet axis.

Derived from the set of circumstances described in the introduction is the object of the present invention. The spray system and the method are to be created in such a way that the mixing of the primary gas into the jet of secondary fluid is as intensive as possible.

An injector, in order to add gas to waste water, is known from German unexamined application DE 2634494. A central propulsive jet nozzle for a liquid jet opens inside a mixing chamber to which a gas is fed. Downstream of the mixing chamber, provision is made for a divergent discharge section.

A combustion chamber feed device, in which a convergent/divergent Venturi nozzle is arranged inside a cylindrical chamber, is known from German printed patent specification DE 2134100 C2. An air-jet nozzle opens into the inlet of the Venturi nozzle. Combustible gas is to be inducted via the Venturi nozzle and is then to be fed to a combustion chamber downstream of said cylindrical chamber.

A spray nozzle, with which a paste-like mass is to be produced, is known from German unexamined application DE 1957344. A discharge section of the nozzle is encompassed by a ring-shaped annular slot which is exposed to admission of compressed air.

A two-component nozzle, which has a plurality of discharge openings which are arranged inside an annular slot, is known from US unexamined specification US 2009/0031923 A1.

A spray system for mixing oxygen into water is known from US printed patent specification U.S. Pat. No. 5,091,118. The fluid is conducted through a passage of convergent/divergent design for this purpose. A central discharge opening for the gas is arranged inside the passage.

With the invention, a spray system and a method for spraying a secondary fluid into a primary fluid are to be improved.

According to the invention, a spray system for spraying a secondary fluid into a primary fluid is provided for this purpose, wherein the secondary fluid is gaseous or liquid or contains fine particulate solids which are to be dispersed in the primary fluid, having at least one central nozzle for the primary fluid and at least one nozzle for spraying the secondary fluid, wherein a nozzle housing of the nozzle is of tubular construction and the central nozzle has a central passage for the primary fluid, wherein the passage, as seen in the flow direction, has a convergent inlet section, a constriction and a divergent discharge section, wherein at least one discharge opening for the secondary fluid is arranged at the downstream-disposed end of the nozzle housing and wherein the at least one discharge opening is designed and arranged in order to create a spray jet of secondary fluid which in an essentially ring-like manner encompasses the primary fluid which discharges from the central passage.

By means of the spray system according to the invention, the primary fluid is not mixed into the secondary fluid exclusively via an outer periphery of the spray jet. Rather, the primary fluid is additionally fed to the central region of the spray jet via the central nozzle.

In this way, this achieves the effect of good evaporation conditions for droplets also existing close to the axis of the spray jet of secondary fluid, or of advantageous boundary conditions prevailing for the mixing of the secondary fluid into the primary fluid. With such a configuration, it is possible to mix a significantly larger mass flow of secondary fluid into the primary fluid with a single nozzle because the sprayed-in secondary fluid is mixed into the primary fluid not only from an outer side of the spray jet but also from the inner side of the spray jet in the direction of the jet axis. Used as primary fluid is flue gas, for example, which is to be cooled, into which a liquid, for example water, is to be sprayed for the purpose of evaporative cooling of the flue gas. Compressed air or steam, for example, can be used as auxiliary atomizing medium.

In a development of the invention, the at least one discharge opening is formed by means of a plurality of discharge openings for the secondary fluid, which are arranged in a ring-like manner at the end of the nozzle housing.

By means of a plurality of discharge openings which are arranged in a ring-like manner, an essentially ring-like spray jet of secondary fluid and auxiliary atomizing medium can be created.

In a development of the invention, each of the plurality of discharge openings for the secondary fluid is encompassed by an annular slot for a gaseous auxiliary atomizing medium.

In this way, a large number of small, individual nozzles, in each case designed as a two-component nozzle with an annular slot, are arranged in a ring-like manner so that together they create a ring-like spray jet which exerts a propulsive jet effect upon the primary fluid. The provision of a plurality of individual nozzles which are arranged in a ring-like manner, for example 12 individual nozzles which are in a ring-like arrangement, offer advantages especially when considerable temperature differences are to be envisaged. Such temperature differences can occur, for example, between a state when spraying is stopped and when spraying is in operation, or between colder liquid to be atomized and hot gaseous auxiliary atomizing medium. Small individual nozzles, with regard to malfunctions as a result of thermal expansion in the region of the spray openings or spray slots, are less vulnerable than one large annular nozzle. In both cases, the slot widths can be selected to be about the same size.

In a development of the invention, the at least one discharge opening is formed by means of a single annular slot which is arranged at the end of the nozzle housing.

In this way, a continuous, ring-like spray jet can be created.

In a development of the invention, the annular slot for the secondary fluid is arranged inside an annular slot for a gaseous auxiliary atomizing medium.

In this way, an encompassing spray jet of secondary fluid and auxiliary atomizing medium can be created, which spray jet totally encompasses the primary fluid which discharges from the passage of the central nozzle.

In a development of the invention, a swirler is arranged in the passage of the central nozzle.

By providing a swirler, the mixing of primary fluid and secondary fluid can be further improved.

In a development of the invention, at least one cleaning nozzle is provided at the upstream-disposed inlet of the passage of the central nozzle for keeping the inlet free of deposits.

As a result of the suction effect of the propulsive jet nozzle configuration in the spray system according to the invention, it is not to be assumed from this that the inlet of the central nozzle for the induction of the primary fluid is blocked by dust deposits since as a result of the suction effect of the propulsive jet nozzle configuration at the inlet of the central nozzle higher flow velocities are induced. With a loading of the primary fluid, for example flue gas, with abrasively acting dust, even erosion damage is more likely to be envisaged at the inlet of the central nozzle so that a corresponding choice of material must be made. In specific cases, however, problems with dust formation in the inlet of the central nozzle may occur. In this case, a small cleaning nozzle can be connected upstream to the central nozzle in such a way that it keeps the inlet free of dust deposits. This cleaning nozzle, or even a plurality of cleaning nozzles, can advantageously be connected to the feed line of the gaseous auxiliary atomizing medium.

In a development of the invention, the nozzle housing of the at least one nozzle is arranged in a duct which conducts the primary fluid. The nozzle housing of the at least one nozzle is advantageously arranged at a distance from a wall of the duct which conducts the primary fluid.

In this way, the nozzle housing can in essence be completely exposed to circumflow by the primary fluid and at the same time the primary fluid can pass through the passage of the central nozzle. The essentially ring-like spray jet of secondary fluid and auxiliary atomizing medium which discharges at the end of the nozzle housing can consequently be encompassed both on its inner side and on its outer side by primary fluid.

In a development of the invention, a longitudinal axis of the central nozzle is arranged parallel to the flow direction in the duct which conducts the primary fluid.

In a development of the invention, the at least one nozzle and the central nozzle are constructed in the form of a propulsive jet pump in such a way that as a result of the propulsive jet effect of the essentially ring-like spray jet which discharges from the at least one discharge opening for the secondary fluid, the primary fluid is inducted at the inlet of the passage of the central nozzle so that downstream of the passage the primary fluid is added both to a central region of the essentially ring-like spray jet which discharges from the discharge opening and to an outer periphery of the essentially ring-like spray jet.

The problem upon which the invention is based is also solved by a method for spraying a secondary fluid into a primary fluid, wherein the secondary fluid is gaseous or liquid or contains fine particulate solids which are to be dispersed in the primary fluid, wherein provision is made for creating an essentially ring-like spray jet of secondary fluid, which also encompasses the downstream-disposed end of the passage, for inducting the primary fluid at the upstream-disposed end of the passage by means of a propulsive jet effect of the ring-like spray jet, and for mixing primary fluid with secondary fluid both in a region between a jet axis of the ring-like spray jet and said spray jet and in a region adjoining an outer periphery of the spray jet.

In this way, a very intensive mixing of gaseous primary fluid into the spray jet of secondary fluid can be achieved.

Further features and advantages of the invention are gathered from the claims and from the following description of preferred embodiments of the invention in conjunction with the drawings. Individual features of the various described embodiments can be combined in this case with each other in any manner without exceeding the scope of the invention.

In the drawings:

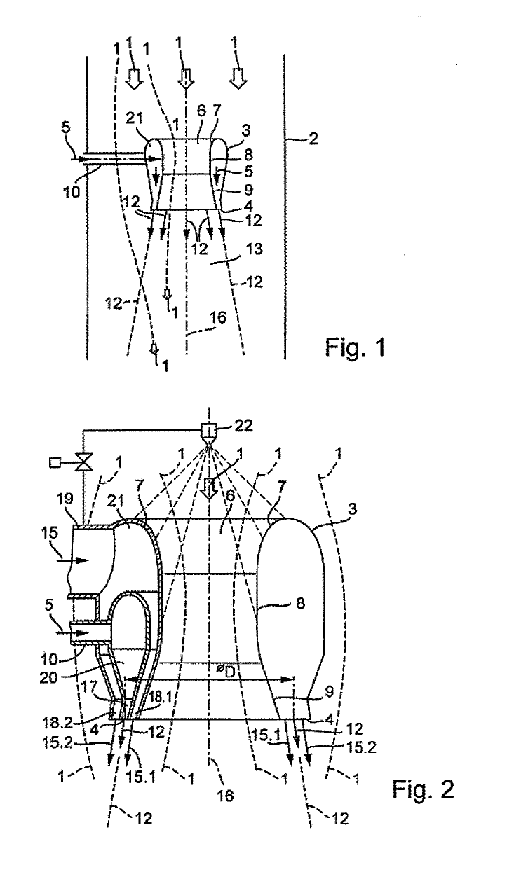

FIG. 1: shows a schematic sectional view of a spray system according to the invention according to a first embodiment,

FIG. 2: shows a schematic sectional view of a spray system according to the invention according to a second embodiment,

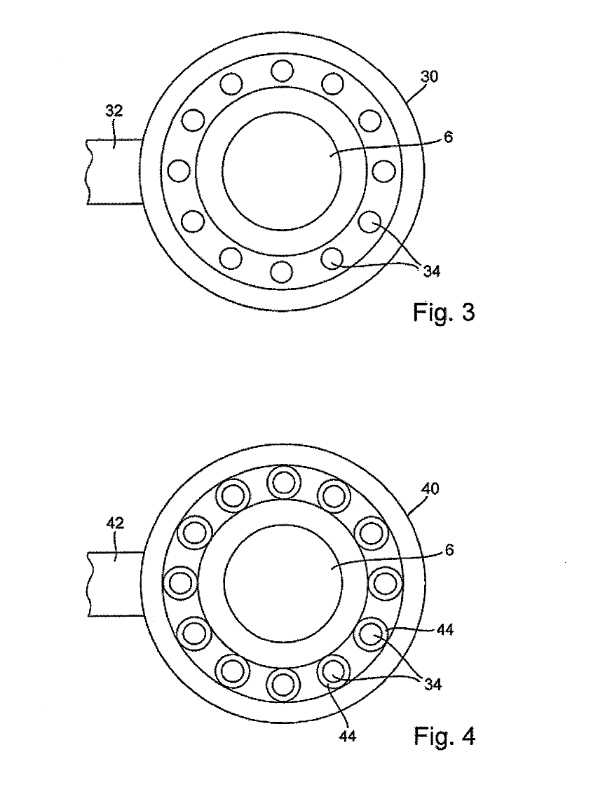

FIG. 3: shows a schematic view of a spray system according to the invention according to a third embodiment against a flow direction, and

FIG. 4: shows a schematic view of a spray system according to the invention according to a fourth embodiment against a flow direction.

The view of FIG. 1 shows a basic configuration of a spray system according to the invention. An annular nozzle housing 3 with a nozzle main axis or with a longitudinal axis 16 is arranged in a flue gas duct 2 which conducts a primary gas 1. A secondary fluid 5, in the form of a ring-like spray jet 12, discharges from this nozzle housing 3 at the outflow-side end 4. In this case, the altogether ring-like spray jet 12 can be formed by a multiplicity of individual jets which are arranged on a ring—cf. FIG. 3, FIG. 4—or, as is shown FIG. 1, by means of a single annular slot jet.

The annular nozzle housing 3 encloses a central nozzle 6 which is formed by means of a passage with a convergent inlet section 7, a constriction 8 and a divergent discharge section 9, which follow in series in the flow direction. The secondary fluid 5 is fed via the pipe 10 to an annular cavity 11 of the annular nozzle housing 3. The secondary fluid 5 fills out this cavity 11 during operation of the nozzle and then discharges at the end 4 of the nozzle housing 3 in the form of the ring-like spray jet 12. As a result of the propulsive jet effect of the spray jet 12, which consists of the sprayed-in secondary fluid 5 and discharges from the annular nozzle housing 3 at the end 4, primary fluid 1 is inducted via the inlet section 7 of the central nozzle 6 and is admixed with the spray jet 12 downstream of the end 4 of the nozzle housing 3. The admixing is carried out in this case in a central region 13 of the spray jet 12 which extends from the center longitudinal axis 16 to the ring-like spray jet 12. In addition, primary fluid 1, which bypasses the annular nozzle housing 3 on the outside, is mixed into the spray jet 12 via the outer periphery, that is to say via the generated surface 14, of said spray jet 12. In this way, a very intensive mixing of the primary fluid 1, especially flue gas, into the spray jet 12 of secondary fluid 12, especially water, can be achieved. According to the invention, a ring-like spray jet 12 of secondary fluid is therefore created and encompasses a core jet of primary gaseous fluid.

According to FIG. 1, the primary fluid 1 is not mixed into the secondary fluid 5 exclusively via the cone envelope of the spray jet 12. Rather, the spray nozzle for the secondary fluid 5 is designed in such a way that it acts as an annular propulsive jet nozzle upon the primary fluid 1. Therefore, the primary fluid 1 is additionally inducted via the central nozzle 6, which resembles the intake of a turbojet engine, and is fed to the central region of the spray jet 12. In this way, it achieves the effect of good evaporation conditions for droplets also existing close to the axis of the spray jet 12, or advantageous boundary conditions existing for the mixing of the secondary fluid 5 into the primary fluid 1. With such a configuration, it is possible to mix a significantly larger mass flow of secondary fluid into the primary fluid 1 with a single nozzle because the sprayed-in secondary fluid 5 is not mixed into the primary fluid 1 just from the cone envelope but also from the jet axis 16.

FIG. 2 shows a longitudinal section through an embodiment of the nozzle according to the invention. The nozzle for the secondary fluid is designed in this case as a two-component nozzle in which a liquid, as secondary fluid, is atomized by a gaseous auxiliary atomizing medium and sprayed into the primary fluid, in this case flue gas which is to be cooled, for the purpose of evaporative cooling of the primary fluid 1. The hot primary gas 1 is axially inducted as a result of the propulsive jet effect of the two-component nozzle and therefore also creates from the outset good boundary conditions for the evaporation of the droplets on the jet axis 16. This two-component nozzle is additionally characterized in that the secondary fluid 5, that is to say the cooling liquid, discharges via a narrow annular slot which extends coaxially to the main axis 16 of the spray nozzle. In addition, further annular slots, via which the auxiliary atomizing medium is blown out, adjoin this annular slot for liquid radially towards on inside and radially on the outside. The annular slots for the cooling liquid and for the auxiliary atomizing medium are supplied from the outside with the corresponding fluids via a feed line.

Instead of one single large annular slot nozzle, as is shown in FIG. 2, which encompasses a central nozzle for the induction of the primary fluid, a large number of small individual nozzles can naturally also be arranged in a ring-like manner in such a way that they commonly exert a ring-like propulsive jet effect upon the primary fluid 1 and therefore axially induct this—see the embodiments according to FIG. 3 and FIG. 4.

It is to be assumed from this that the inlet of the central nozzle 6 for the induction of the primary fluid 1 is not blocked by dust deposits since as a result of the suction effect of the propulsive jet nozzle configuration higher flow velocities are induced here. With a loading of the primary gas 1 with abrasively acting dust particles, erosion damage is even more likely to be envisaged in the inlet of the propulsive jet nozzle, that is to say of the central nozzle 6, so that a corresponding choice of material has to be made. If in specific cases, however, problems with the formation of deposits in the inlet of the central nozzle 6 should occur, a small cleaning nozzle can be connected upstream to the central nozzle 6 in such a way that it keeps the inlet free of dust deposits. Such a cleaning nozzle 22 is also schematically shown in FIG. 2. This cleaning nozzle 22 could be connected to the feed line of the gaseous auxiliary atomizing medium, for example.

A significant example of such an annular slot nozzle lies in the fact that the distribution of the secondary fluid 5 and of the auxiliary atomizing medium to the spray nozzle can be designed considerably more simply than in the case of a cluster nozzle which consists of a multiplicity of individual nozzles.

This especially applies to emergency spraying which has to be started only in rare exceptional cases. These cluster nozzles can be exposed to admission of fluids with very different temperatures, for example water at 20° C. and steam at 300° C., which serve as auxiliary atomizing medium. The distribution of the water and of the steam to the individual nozzles of the cluster nozzles is associated with high cost here and also with the risk of appreciable thermal stresses.

In the nozzle according to FIG. 2, the secondary fluid 5 is sprayed into the primary fluid 1 by means of an auxiliary atomizing medium 15. The secondary fluid 5 discharges from an annular slot 17—extending concentrically to the main axis 16 of the nozzle housing 3—at the end 4 of said nozzle housing 3. A ring-like spray jet 12 of secondary fluid is created. This ring-like spray jet 12 is tangential to both sides of annular jets 15.1 and 15.2 which consist of auxiliary atomizing medium and lead to a fast disintegration of the spray jet 12 of secondary fluid. These annular jets 15.1 and 15.2 are created by the auxiliary atomizing medium 15 which discharges from the annular slots 18.1 and 18.2 which are also concentric to the main axis 16. The effect of the spray jet 12 of secondary fluid 5 and also the effect of the annular jets 15.1 and 15.2 of auxiliary atomizing medium 15 upon the primary fluid 1 is largely the same as in the case of the nozzle which is described which reference to FIG. 1. Consequently, primary fluid 1 is also inducted via the central nozzle 6 in this case and from the nozzle axis 16 is mixed into the spray jet 12 of secondary fluid 5. The feed of secondary fluid 5 is carried out via at least one pipe 10. The feed of auxiliary atomizing medium 15 is carried out via at least one pipe 19. The secondary fluid 5 is fed to the annular slot 17 through the nozzle housing 3 which has a hollow body of revolution 20 which is symmetrical to the main axis. The auxiliary atomizing medium 15 is also fed to the annular slots 18.1 and 18.2 via the nozzle housing 3 which has a further hollow body of revolution 21 which is symmetrical to the main axis 16.

The nozzle housing 3 forms the toroidal hollow body of revolution 21 which is supplied with auxiliary atomizing medium 15 via the feed line 19. Arranged inside the hollow body of revolution 21 is the additional, also toroidal, hollow body of revolution 20 which is smaller than the hollow body of revolution 21 and which is supplied with the secondary fluid 5 via the feed line 10. The hollow body of revolution 20 has an upstream-disposed end which is approximately semicircular, as seen in the cross section of FIG. 2, and tapers to the annular slot 17, as seen in the flow direction. The wall sections of the hollow body of revolution 20 which delimit the annular slot 17 are arranged at an angle to the main axis 16 so that each of the outer walls of the annular slot 17 forms a widening truncated cone, as seen in the flow direction. The wall sections of the hollow body of revolution 20 which delimit the annular slot are not arranged parallel to each other but in a manner slightly tapering towards each other, as seen in the flow direction. The hollow body of revolution 20 consequently forms a streamlined body-like shape, as seen in the cross section of FIG. 2.

The hollow body of revolution 20 is arranged in the larger hollow body of revolution 21 which also forms a streamlined body-like shape, as seen in the cross section of FIG. 2. At the upstream-disposed end, the hollow body of revolution 21 is formed approximately in the shape of a circle section. This section forms by its inner side the inlet of the central nozzle 6. Adjoining the inlet 7, the hollow body of revolution 21 has walls which are arranged concentrically to the main axis 16 and consequently form the constriction 8 of the passage of the central nozzle 6. Adjoining these walls which are arranged concentrically to the main axis 16, the hollow body of revolution 21 tapers in the style of a streamlined body. The inner wall of the hollow body of revolution 21 which faces the main axis 16 consequently forms the discharge section 9 of the passage of the central nozzle 6.

In the region of its downstream-disposed end, the hollow body of revolution 21 forms the two annular slots 18.1 and 18.2. For this, the outer walls of the hollow body of revolution 21, in the region of the annular slot 17 of the hollow body of revolution 20, are directed essentially parallel to the outer walls of the hollow body of revolution 20. The annular slot 18.1 is consequently created between the hollow body of revolution 20 and the inner wall of the hollow body of revolution 21, as seen in the direction of the main axis 16. The annular slot 18.2 is formed between the outer wall of the hollow body of revolution 20 and the outer wall of the hollow body of revolution 21, as seen outwardly from the main axis 16. The annular slots 18.1 and 18.2, as is to be gathered from FIG. 2, are approximately of equal width. The annular slot 17, in the depicted embodiment, is also of the same width as the annular slots 18.1 and 18.2. It is possible within the scope of the invention to design the slot widths differently. The annular slots 17 and also 18.1 and 18.2 are arranged so that they form in each case a truncated cone which widens in the flow direction. The discharged, ring-like spray jets 12 or 15.1 and 15.2 therefore also widen in a truncated cone-like manner, as seen in the flow direction.

The views of FIGS. 1 and 2 are schematic and reference is specifically to be made to the fact that in FIG. 1 the nozzle housing 3, in comparison to the diameter of the flue gas duct 2 or of a vessel penetrated by flue gas, is excessively large in its representation since a drawing to scale would not be informative. In actual fact, the diameter D of the nozzle housing 3, as marked in FIG. 2, lies within the order of magnitude of 30 mm to 150 mm, whereas the diameter of the flue gas ducts 2 or vessels range within the order of magnitude of about 2000 mm to about 15,000 mm. The order of magnitude of the water flow to be atomized into small droplets using such a nozzle according to the invention lies at 100 l/min for a ring diameter of 100 mm if the initial pressure of the auxiliary atomizing medium, being air, lies at about 6 bar. The width of the annular slot 17 for the secondary fluid 5—see FIG. 2—and also the width of the annular slots 18.1 and 18.2 for the auxiliary atomizing medium 15 lies within the order of magnitude of 0.1 mm to 1.5 mm.

If steam is used as auxiliary atomizing medium 15, it can be advantageous to thermally insulate the water-conducting components, that is to say the components which conduct the secondary fluid 5, against the steam-conducting components.

By means of the invention, a spray system, consisting of at least one nozzle for spraying a liquid or gaseous secondary fluid into a primary fluid or for dispersing fine particulate solids in said primary fluid, is therefore created, characterized in that the spray system is constructed in the form of a propulsive jet pump which inducts primary fluid and feeds it to the central region of the spray jet. The spray system can be constructed in this case from a multiplicity of individual nozzles which in a ring-like manner encompass a central nozzle, via which primary fluid is inducted. Alternatively, the spray system can consist of a single annular slot nozzle, via which the secondary fluid is sprayed in, with or without auxiliary atomizing medium, and this annular slot nozzle encompasses in a ring-like manner a central nozzle, via which primary fluid is inducted. A swirler can be arranged in the central nozzle.

The invention therefore refers to devices and methods for spraying fluids and for dispersing solids in ducts or vessels through which a primary gas flows. According to the invention, at least one nozzle is used for spraying a fluid or for dispersing fine particulate solids in said ducts or vessels. According to the invention, a multi-component nozzle is provided with a primary gas core jet. The invention is used for example in flue gas ducts or in flue gas scrubbing plants in power plants or in the cement industry.

The view of FIG. 3 shows a spray system according to the invention according to a third embodiment of the invention. An annular nozzle housing is of toroidal design and has a shape which is similar to the nozzle housing 3 of FIG. 1. The nozzle housing 30 forms a hollow body of revolution, to which secondary fluid is fed via a feed line 32. The feed line 32 also serves for the fastening of the nozzle housing 30 on the wall of a flue gas duct—cf. FIG. 2. The annular nozzle housing 30 encompasses a passage of a central nozzle 6 for primary fluid. The passage of the central nozzle 6, as seen in the flow direction, has a convergent inlet, a constriction and a divergent discharge section and is designed similar to the passage of the central nozzle 6 in FIGS. 1 and 2. The nozzle housing 30 in the view of FIG. 3 is shown opposite the flow direction. A discharge opening for the secondary fluid is formed by twelve discharge openings 34 which are circular in each case and are arranged in a way in which they encompass the end of the passage of the central nozzle in a ring-like manner. By means of the discharge openings 34, an essentially ring-like spray jet of secondary fluid is created overall, which spray jet, as was explained based on the embodiments of FIGS. 1 and 2, exerts a propulsive jet effect upon the primary fluid inside the passage of the central nozzle 6. The principle of operation of the spray system which is schematically shown in FIG. 3 is consequently the same as the principle of operation of the spray systems according to the invention which are described with reference to FIGS. 1 and 2.

The view of FIG. 4 shows a further spray system according to the invention with an annular nozzle housing 40 which has a toroidal shape, as was previously described with reference to FIGS. 1 and 2 and to the nozzle housing 3. The nozzle housing 40 is connected to an inner wall of a flue gas duct via a pipe 42—see FIG. 1. Arranged in the pipe 42 are feed lines, which are not shown, for secondary fluid and for gaseous auxiliary atomizing medium, for example water or compressed air or steam. At a downstream-disposed end of the nozzle housing 40, as in the case of the spray system of FIG. 3, altogether twelve discharge openings 34 for secondary fluid are arranged in a ring-like manner. Each of the discharge openings 34 for secondary fluid is encompassed by an annular slot 44 for the gaseous auxiliary atomizing medium. The discharge openings 34 and the respectively encompassing annular slots 44 altogether form a ring-like spray jet of secondary fluid and auxiliary atomizing medium. This ring-like spray jet, as in the case of the previously described embodiments of FIGS. 1 to 3, exert a suction effect upon the primary fluid also at the inlet of the passage of the central nozzle 6. The principle of operation of the spray system which is shown in FIG. 4 is therefore the same as was previously described based on the spray systems of FIGS. 1 to 3.

In a way not shown, each of the discharge openings 34 for secondary fluid can itself be constructed as an annular slot opening.

1. A spray system for spraying a secondary fluid into a primary fluid, wherein the secondary fluid is gaseous or liquid or contains fine particulate solids which are to be dispersed in the primary fluid, with at least one central nozzle for the primary fluid and at least one nozzle for spraying the secondary fluid, wherein a nozzle housing of the nozzle is of tubular construction and the central nozzle has a central passage for the primary fluid, wherein the passage, as seen in the flow direction, has a convergent inlet section, a constriction and a divergent discharge section, in that at least one discharge opening for the secondary fluid is arranged at the downstream-disposed end of the nozzle housing and in that the at least one discharge opening is designed and arranged in order to create a spray jet of secondary fluid which in an essentially ring-like manner encompasses the primary fluid which discharges from the central passage.

2. The spray system as claimed in claim 1, wherein the at least one discharge opening is formed by means of a plurality of discharge openings for the secondary fluid which are arranged in a ring-like manner at the end of the nozzle housing.

3. The spray system as claimed in claim 2, wherein each of the plurality of discharge openings for the secondary fluid is encompassed by an annular slot for a gaseous auxiliary atomizing medium.

4. The spray system as claimed in claim 1, wherein the at least one discharge opening is formed by means of a single annular slot which is arranged at the end of the nozzle housing.

5. The spray system as claimed in claim 4, wherein the annular slot for the secondary fluid is arranged inside an annular slot for a gaseous auxiliary atomizing medium.

6. The spray system as claimed in claim 1, wherein the at least one discharge opening is designed and arranged in order to create a ring-like spray jet which conically widens from the end of the nozzle housing.

7. The spray system as claimed in claim 1, wherein a swirler is arranged in the passage of the central nozzle.

8. The spray system as claimed in claim 1, wherein at least one cleaning nozzle is provided at the upstream-disposed inlet of the passage of the central nozzle for keeping the inlet free of deposits.

9. The spray system as claimed in claim 8, wherein the at least one cleaning nozzle is connected to a feed line of a gaseous auxiliary atomizing medium.

10. The spray system as claimed in claim 1, wherein the nozzle housing of the at least one nozzle is arranged in a duct which conducts the primary fluid.

11. The spray system as claimed in claim 10, wherein the nozzle housing of the at least one nozzle is arranged at a distance from a wall of the duct which conducts the primary fluid.

12. The spray system as claimed in claim 10, wherein a center longitudinal axis of the central nozzle is arranged parallel to the flow direction in the duct which conducts the primary fluid.

13. The spray system as claimed in claim 1, wherein the at least one nozzle and the central nozzle are constructed in the form of a propulsive jet pump in such a way that as a result of the propulsive jet effect of the essentially ring-like spray jet which discharges from the at least one discharge opening for the secondary fluid, the primary fluid is inducted at the inlet of the passage of the central nozzle so that downstream of the passage the primary fluid is admixed both with a central region of the essentially ring-like spray jet which discharges from the discharge opening and with an outer periphery of the essentially ring-like spray jet.

14. A method for spraying a secondary fluid into a primary fluid, wherein the secondary fluid is gaseous or liquid or contains fine particulate solids which are to be dispersed in the primary fluid, with a spray system as claimed in claim 1, wherein by creating an essentially ring-like spray jet of secondary fluid, which also encompasses the downstream-disposed end of the passage, by inducting the primary fluid at the upstream-disposed end of the passage by means of a propulsive jet effect of the ring-like spray jet, and by mixing primary fluid with secondary fluid both in a region between a jet axis of the ring-like spray jet and said spray jet and in a region adjoining an outer periphery of the spray jet.
